(19) United States
(12) Patent Application Publication
(10) Pub. No.: US 2013/0119208 A1
(43) Pub. Date: May 16, 2013

(54) FIR TREE MOUNT FOR CABLE TIES

(71) Applicant: HELLERMANNTYTON CORPORATION, Milwaukee, WI (US)

(72) Inventor: GERARD G. GEIGER, Jackson, WI (US)

(73) Assignee: HELLERMANNTYTON CORPORATION, Milwaukee, WI (US)

(21) Appl. No.: 13/738,567

(22) Filed: Jan. 10, 2013

Related U.S. Application Data
(63) Continuation-in-part of application No. 13/220,308, filed on Aug. 29, 2011.
Application No. 13/220,308 is a continuation-in-part of application No. 10/835,864, filed on Apr. 30, 2004, now Pat. No. 8,028,962.

(51) Int. Cl. F16L 3/233

(52) U.S. Cl. CPC F16L 3/233
USPC 248/68.1

(57) ABSTRACT

The disclosed device provides an improved mounting assembly for securely supporting elongated items against a surface. The assembly provides a mount with an integrally formed flexible tie for retaining the items.

The tie includes an aperture having a tab, which provides frictional force for the flexible tie tail when it is placed through the aperture for securing selected items. The device further includes a mounting stud having staggered or asymmetrical branch rows that extend from either side of a center section of the stud. The device may also include a diaphragm extending downwardly from the mount. The diaphragm will provide tension and resistance when the mounting stud is inserted into a supporting surface.

### RELATED APPLICATIONS

This application is a continuation-in-part of co-pending U.S. patent application Ser. No. 13/220,308, filed 29 Aug. 2011, which is a continuation-in-part of U.S. patent application Ser. No. 10/835,864, filed 30 Apr. 2004; now U.S. Pat. No. 8,028,962.

### BACKGROUND OF THE INVENTION

This invention relates generally to hardware for securing bundled elongate articles, such as wires, cables, hoses, tubing, fiber optics, conduits, vines, etc., to a supporting structure. More particularly, the invention relates to a mounting element for securing elongated articles, extending from the hardware and into the supporting structure or its facing surface.

Flexible ties are widely used to secure elongate items, such as wires, cables, hoses and tubes, into compact, secure bundles. Typically, such ties include a head and a flexible strap, which terminates in a tail. In use, the tie is inserted through the head or slotted opening of a mount, such as a saddle mount, and then looped around the elongate item. The tail is then pulled tight to pull the strap around the articles, and thereby secure the articles into a compact, neat bundle. A pawl mechanism within the head secures the strap against withdrawal.

In many applications, it is sufficient to merely secure the items into a bundle. Such applications might include, for example, stationary electronic equipment that remains in one place and is subject to little or no vibration in use. In other applications, it is necessary or desirable not only to secure the items into a bundle, but to secure the resulting bundle to a supporting chassis or framework as well. Such applications are also common, for example, in cars, trucks, airplanes, ships, boats and other vehicles where the bundle is likely to be subjected to severe jostling and vibration. In other applications (e.g. buildings), where vibration might not be an important consideration, it is still desirable to secure cables, hoses, tubes, etc., to a fixed structure.

Generally, the strap and the mount will be manufactured as separate items. However, since the strap and mount are used together, it is advantageous that the items be located near each other before being used for bundling an object or objects. Preferably, the items would be loosely joined together in some fashion, or may be integrally formed with the mount, as in the present invention. Likewise, many mounts do not provide an efficient, tight grip when applied to a support surface. Previous Christmas tree or fir tree mounts, such as U.S. Pat. No. 5,921,510, issued to Benoit et al., contemplate strengthened mounting studs, but still leave room for improvement. Such mounts may not provide sufficient resistance and tightness against the support surface for adequately supporting a bundled item. The present invention provides for an improved mounting assembly to address these problems.

### SUMMARY OF THE INVENTION

The present invention provides an improved mounting assembly for securely supporting bundled items against a supporting surface. The assembly provides a mount with an aperture, which interacts with a flexible tie tail for bundling the items. The tie may be integrally formed with the assembly. The aperture contains a tab, which provides frictional force for the flexible tie when the tie tail is inserted in the aperture during bundling.

The invention may also include a diaphragm spring and a mounting stud extending downwardly from the mount. The diaphragm spring will provide tension and resistance when the mounting stud is inserted into the supporting surface. Branches extend from either side of a center section of the stud. The branches are arranged in branch rows located about the stud, wherein the branch rows are preferably staggered or asymmetrical from one another around the center section of the stud. A mounting assembly according to the present invention may include any combination of the above features.

### BRIEF DESCRIPTION OF THE DRAWINGS

FIG. 1 is a perspective view of a mounting device designed in accordance with the present invention securing a bundled object to a support surface, shown in phantom.

FIG. 2 is a perspective view of a mounting device designed in accordance with the present invention.

FIG. 3 is a side view of a mounting device designed in accordance with the present invention.

FIG. 4 is side view of a mounting device designed in accordance with the present invention rotated 90° from the view of FIG. 3.

FIG. 5 is a sectional view of a mounting device designed in accordance with the present invention taken along line 5-5 of FIG. 3.

FIG. 6 is a bottom view of a mounting device designed in accordance with the present invention.

FIG. 7 is a sectional view of the mounting device illustrated in FIGS. 1-6 and showing the device after insertion into a threaded support surface.

FIG. 8 is a sectional view similar to that of FIG. 7 but showing the threaded support surface in phantom.

FIG. 9 is a sectional view similar to that of FIG. 7, but showing the device after insertion into a non-threaded support surface.

FIG. 9A is a sectional view similar to that of FIG. 9, and showing the device after insertion into a support surface.

FIGS. 10-14 depict different embodiments of a mounting device designed in accordance with the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

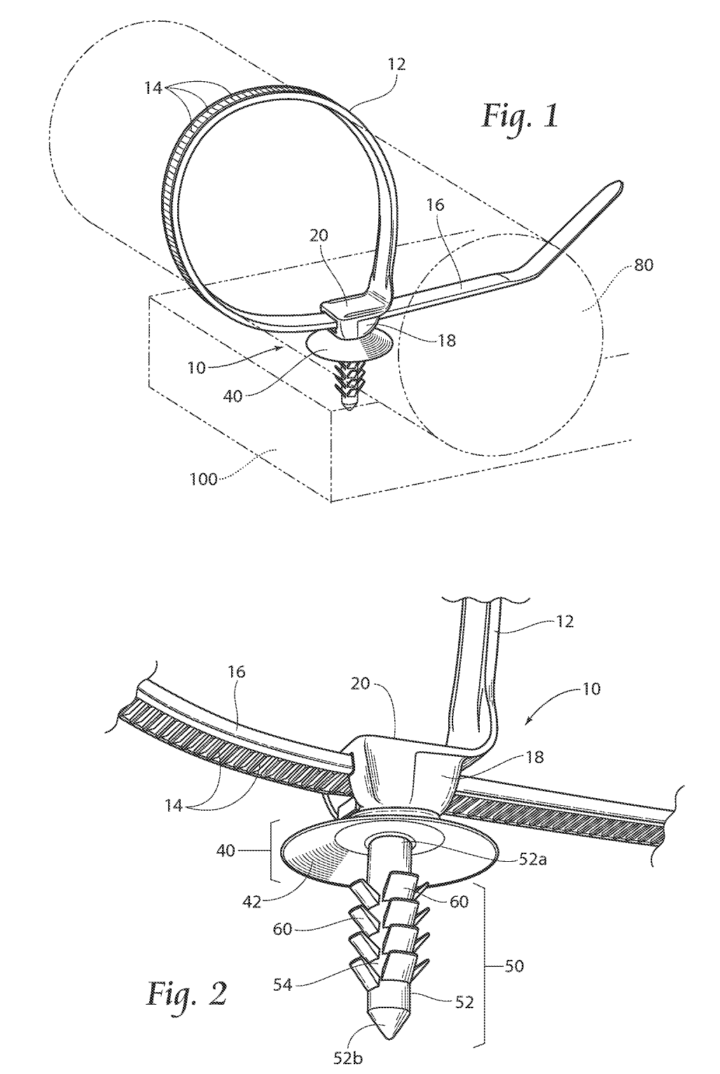

FIG. 1 shows a mounting device 10 according to the present invention securing an elongated object or bundle 80 to a support surface 100 (seen in phantom). An elongated tie 12 having a tie tail 16, and a tie head 18 may be integrally formed with the mounting device 10 for use in wrapping and securing around the bundle 80, and to thereby secure the bundle 80 to the mounting device 10, which is in turn secured to the support surface 100. The bundle 80 may consist of a single object or several objects, such as wires, cables, hoses, tubing, or other elongated articles. It will be apparent that the bundle 80 may comprise a bundle of individual wires or cables, rigid or flexible conduit, hot or cold fluid transporting tubes, or hoses. The bundle 80 may also be contained within the bore of a conventional tubular conduit. Likewise, the bundle 80 may be of various sizes and yet be accommodated by the device 10.

FIG. 2 shows a fragmentary perspective view of the mounting device 10. As illustrated, the mounting device 10 may include an integrally formed tie portion 12 having an object support surface 20, a spring section 40 located below the support surface 20 on the head portion 18, and a mounting section 50 extending downwardly from the support surface 20 and the spring section 40. Each of these sections will be described in more detail with respect to the following figures.

As seen, the support surface 20 may be located adjacent a tie head 18. The support surface 20 provides support for the bundled bundle 80 while the tie head 18 provides attachment for the tie tail 16. The spring section 40 and the mounting section 50 extend from the head 18. It should be understood that the support surface 20 and the tie head 18 should not be limited to any specific orientation. If the mounting device 10 were mounted so that it hung downwardly from the support surface 100, the tie head 18 would be the surface nearest to the support surface 100, even though the tie head 18 would be orientated spatially above the support surface 20.

Referring to FIGS. 2 and 5, the spring section 40 is generally comprised of a flexible disk or diaphragm spring 42. As seen, the diaphragm spring 42 preferably extends downwardly from the tie head 18. The diaphragm spring 42 tapers downwardly and outwardly from a first end 44 located at the tie head 18 to a second end 46. The diaphragm spring 42 is shown as being circular or conical. However, the shape and structure may be of any arrangement that will provide the necessary resistance for the spring section. For instance, the diaphragm spring 42 may consist of a pyramidal shape of any number of sides, which may or may not have each of the sides connected to an adjoining side.

Referring now to FIGS. 2-5, the mounting section 50 may be seen as comprised primarily of a mounting stud 52, having a proximal end 52a located adjacent the tie head 18, and a distal end 52b located opposite the proximal end 52a. The mounting stud 52 extends downwardly from the tie head 18. The mounting stud 52 also may be considered to extend downwardly from the spring section 40. However, the spring section 40 may be arranged so that it surrounds the proximal end 52a of the mounting stud 52 and the stud 52 does not actually depend from the spring section 40 or the diaphragm spring 42. Either arrangement should not be considered limiting on the invention, and both would fall within the scope of the invention. As seen, the mounting stud 52 includes a center section 54 substantially coextensive with the lengthwise dimension of the mounting stud 52.

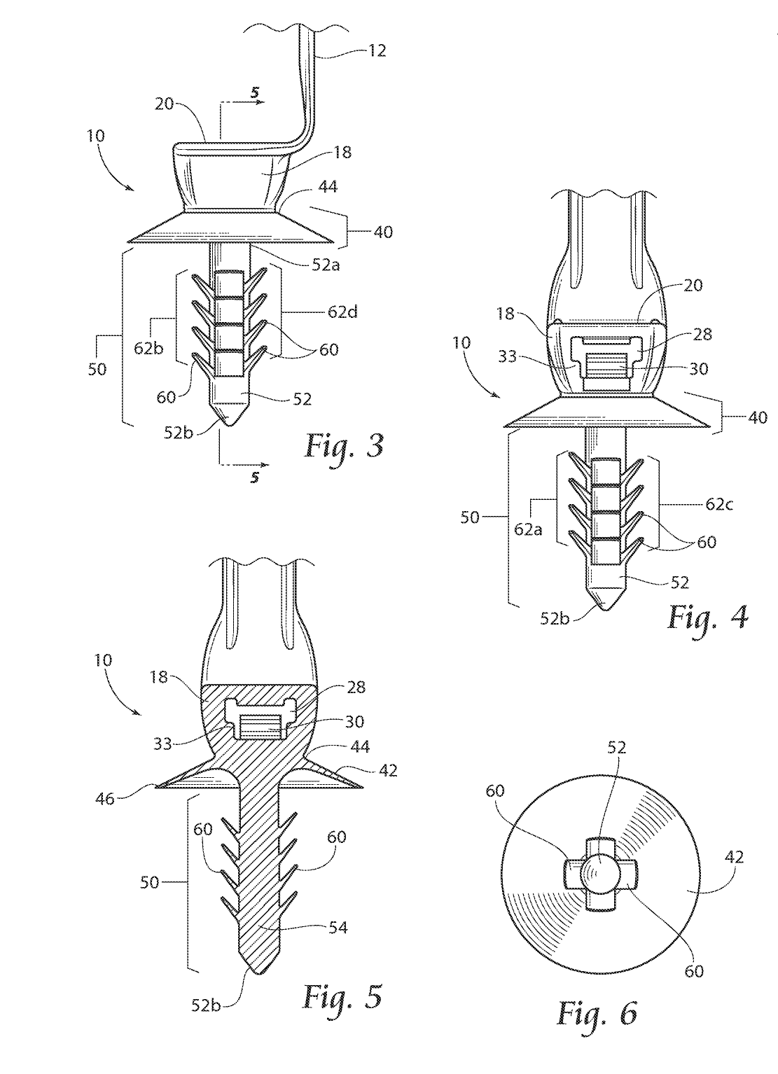

FIGS. 3- show the mounting stud 52 having a plurality of extensions or branches 60 radially extending from the center section 54. Such an arrangement is sometimes referred to generally as a fir tree mounting stud or a Christmas tree mounting stud. As seen, the branches 60 extend outwardly from the center section 54 and are longitudinally spaced from one another and are tapered upwardly towards the tie head 18. As seen, the branches 60 are arranged in branch rows 62a, 62b, 62c, 62d. Preferably, the individual branches 60 are evenly spaced between one another in each row, however, and as shown, the branch rows 62a, 62b, 62c, 62d are not symmetrically aligned with one another, and preferably, the rows 62a, 62b, 62c, 62d are arranged such that the respective branches 60 lie in parallel planes extending half way between the parallel planes formed by two adjacent rows 62a, 62b, 62c, 62d.

The staggered arrangement of the branch rows 62a, 62b, 62c, 62d allows for a stronger and a more easily insertable mounting device 10 than in previous designs with symmetrical designs. As the stud 52 is inserted into the supporting surface 100, only one of the branches 60 will make contact with the support surface 100, thereby easing insertion of the stud 52. Further, the staggered arrangement of the branches 60 provides more opportunities to grab and retain the supporting surface 100 than in previous mounts of similar sizes. The staggering of the branch rows 62a, 62b, 62c, 62d allows retention that would not be possible in a normally arranged stud. Since the branch rows 62a, 62b, 62c, 62d are not symmetrically aligned with one another, the force to pull the stud 52 from the support surface 100 is increased. As may seen particularly in FIG. 8, the branches 60a, 60b, 60c, 60d engage the support surface 100 at differing angles from one another, which increases the necessary pullout force and provides for a more secured stud 52. Further, the staggered branch row 62a, 62b, 62c, 62d arrangement greatly reduces the required pitch of the branches as compared to that seen in known symmetrical designs. As seen, the engagement distance between individual branches 60 is much less than in a symmetrical design since there are four engagement stops to every single engagement stop on a symmetrical fir tree mount having an equal length. Essentially, the present mounting stud 10 multiplies the ability to form a tight grip in a supporting surface compared to previously designed studs having the same length as the present invention.

Likewise, if the branch rows 62a, 62b, 62c, 62d were not staggered and were located evenly around the mounting section 52 while being spaced as presently disclosed, the branches 60 would be situated too close to one another to provide an efficient mounting device. Furthermore, the branches would be too close together to be properly molded, which is a possible method of forming the stud 52. Another design feature of the branches 60 is their shape and size. Preferably the branches 60 of the present invention are designed as short, stubby branches with as large a center diameter as possible. Such an arrangement contributes to the strength of the stud 52 discussed above.

It should be noted that the branches 60 could also be of different shapes and designs from that shown. The branches 60 could be of a warped shape, wavy, or constructed according to other constructions as necessary. Likewise, the stud 52 could be oval or another shape depending on the shape of the bore for the stud 52 to enter.

Still referring to FIGS. 4 and 5, the tie head 18 further includes an aperture 28 having a tab or pawl 30 extending into the aperture 28. The tab 30 engages the elongated tie tail 16 when the tail 16 is inserted into the aperture 28, preferably movably engaging with a plurality of serrations 14 located on the tail 16 (see FIGS. 1 and 2). The tab 30 provides resistance and friction for the elongated tie 12 when it is secured around a bundle 80.

FIG. 4 shows a side view of the mounting device 10, rotated 90° from the view shown in FIG. 3. As seen, the width of the center section 54 and the branches 60 is preferably uniform. The uniform diameter of the center section 54 allows for the branches 60 to be formed shorter and thicker than previous designs, which provides for a more secure mounting device 10.

FIG. 5 shows a sectional view of the mounting device 10. As previously stated, a molding process may form the mounting device 10. The present arrangement allows for the tab 30 to be molded so that it is strong enough to resist movement of the tie 12 when it is inserted into the aperture 28, while being flexible enough to bend when the tie 12 is securing a bundle.

With reference now to FIG. 2, the mounting device 10 may be seen interacting with the integral elongated tie tail 16 prior to the tail 16 being secured around the bundled bundle 80 (as shown in FIG. 1). The tie tail 16 is inserted through the aperture 28 and may be moved forward and backward as necessary. The tab 30 provides resistance for the tie tail 16 sufficient enough so that the tie tail 16 will be retained under normal forces that may be encountered when moving or grabbing the mounting device 10. The tab 30 holds the tie tail 16 in a ready position so that the tie tail 16 is in proper orientation to allow immediate cinching or wrapping of a bundle. FIGS. 4 and 5 also show a pair of shoulders 33 extending upwardly and into the aperture 28. The shoulders 33 are preferably located on either side of the tab 30. When the bundle 80 is secured (see FIGS. 1 and 2) , the tie tail 16 will be pulled so that the tab 30 flexes and the tie 12 may be tightened around the bundle 80. The shoulders 33 provide a solid resistance that the tail 16 will abut, thereby firmly securing the bundle 80. The tab 30 will flex sufficiently enough to not interfere with tail 16 abutting the shoulders 33. Moreover, the shoulders 33 create a recessed channel for the tab 30, thereby allowing the tab 30 to have proper dimensions that will allow the tab 30 flex during tail 16 insertion and being rigid enough to hold the tail 16 in place when insertion has happened. The arrangement and number of shoulders 33 and the tab 30 may differ from that shown in the drawings.

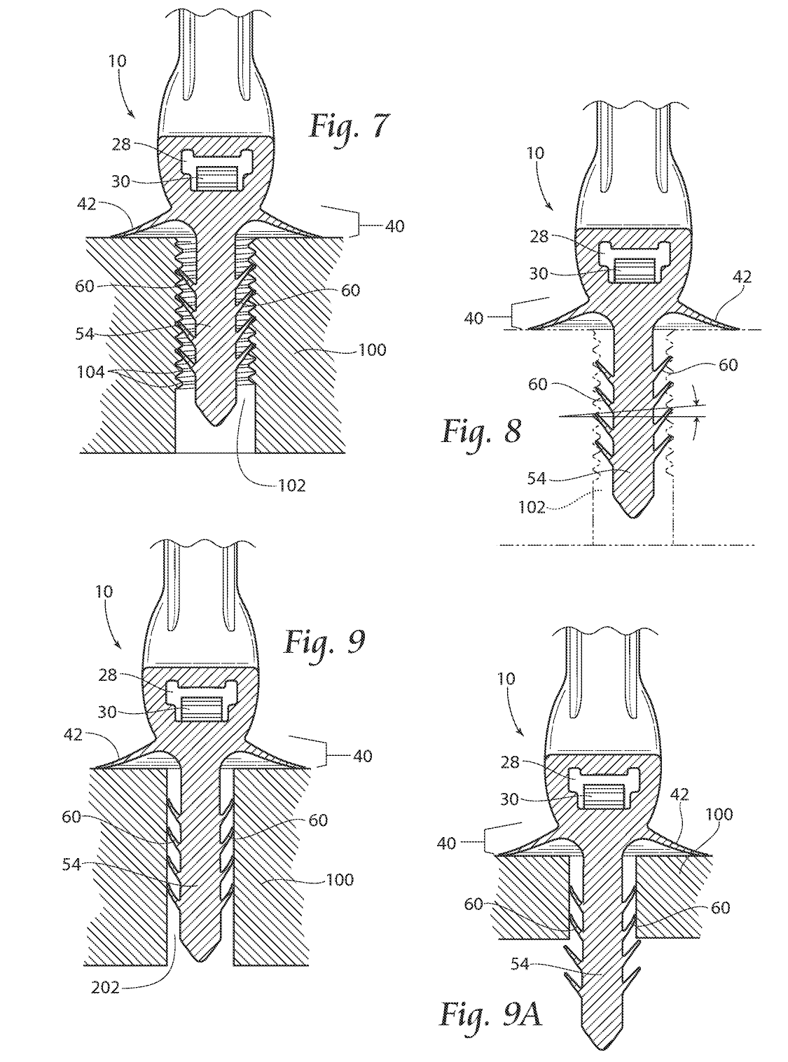

FIG. 6 is a bottom view of the device 10 and showing a bottom view of the diaphragm spring 42. The diameter of the diaphragm spring 42 is preferably greater than that of the mounting stud 52. Thus, when the mounting stud 52 is inserted into the support surface 100 (see FIGS. 7-9), the diaphragm spring 42 provides a sufficient area so that it may flex against the support surface 100 and provide a tight fitting arrangement for the mounting device 10. Also, the diameter of the diaphragm spring 42 is sufficient so that the mounting stud 52 will not prohibit the diaphragm spring 42 from flexing against the support surface 100. As previously stated, the diaphragm spring 42 is shown as circular, but it should be understood that any flexible geometric design or shape is capable of acting as the diaphragm spring 42.

FIGS. 7 and 8 illustrate sectional views of the mounting stud 52, similar to that of FIG. 5, but showing the device 10 in use and inserted in a support 100 having a threaded bore 102. As seen, the branches 60 engage threading 104 in the bore 102 to resist pull out. FIG. 8 particularly illustrates the manner in which the offset branch rows 62a, 62b, 62c, 62d allow a more secure engagement of the staggered individual branches 60 to threads 104.

FIG. 9 shows the mounting device 10 being inserted into a support surface 100. FIG. 9 is essentially the same as FIG. 7, except that FIG. 9 shows a support surface 100 having a non-threaded bore 202. FIG. 9A is similar to that of FIG. 9, except that FIG. 9A shows a thinner support surface 100. The present invention has an advantage over previous designs in that it is well suited to form a tight grip in varying support surfaces 100 including those with threaded or non-threaded bores, and also in support surfaces 100 of varying thicknesses, especially because of the design of the mounting section 50 with staggered branch rows 62a, 62b, 62c, 62d.

The mounting stud 52 can be driven into the bore 102, 202 either by hand or with a hammer of some sort (i.e. a rubber mallet). As the mounting stud 52 enters the bore 102, the branches 60 engage the sides of the bore 102, 202. As seen particularly in the view of FIGS. 7 and 8, when the bore 102 is provided with threading 104, the staggered design of the branch rows 62a, 62b, 62c, 62d allows more frequent engagement with the threads 104 than in previous designs, thereby retaining the mounting stud 52 more efficiently. Even when the bore 202 is relatively smooth, as seen in FIG. 9, the staggered row 62a, 62b, 62c, 62d design of the present invention provides a more secure engagement and therefore more secure retention of the device 10 to the support 100. As seen, the branches 60 are shown flexed against the threading 104 of the bore 102. When the mounting device 10 is pulled out of the bore 102, the branches 60 resist such movement, especially in the longer bores 102, 202 shown, that have been tapped or located in a masonic surface. The diaphragm spring 42 is also shown in

FIGS. 7-9. FIGS. 3-5 show the diaphragm spring 42 in a normal, relaxed position. As the mounting stud 52 moves into the bore 102, the diaphragm spring 42 is flexed against the support surface 100 (see FIGS. 7 and 9). The resulting arrangement provides for a tighter fit of the mounting stud 52 against the support surface 100 than in previous designs. The diaphragm spring 42, which provides a preload spring tension, adds tightness for the mounting stud 52 against the support surface 100. The mounting stud 52 is retained in the bore 102, however, due to the retaining force of the branches 60. Even with the staggered arrangement of the branch rows 62a, 62b, 62c, 62d, there still is a possibility that a gap may be present between the support surface 100 and the mounting device 10. The diaphragm spring 42 fills in the gap in such an instance.

All of the features discussed in the invention may be present in a single mounting device 10, or a mounting device 10 may contain one of the described features and still fall within the scope of the invention. Preferably the components for the mounting device 10 are injection molded from a strong, durable plastic, such as Nylon 6/6.

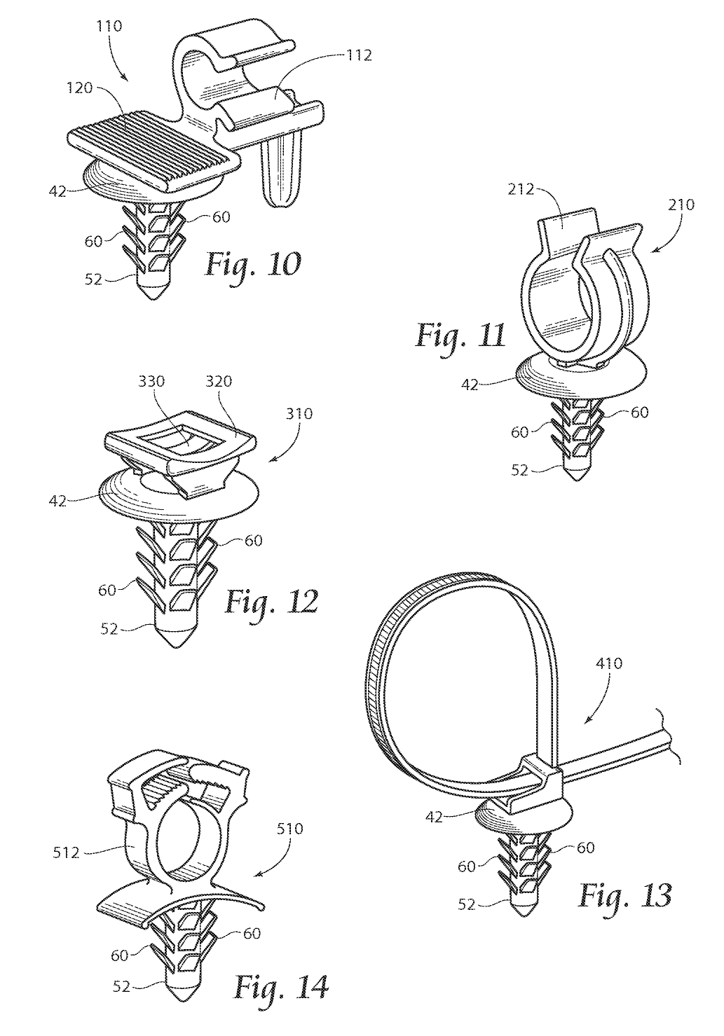

FIGS. 10- 4 illustrate examples of the features of the present invention used in other embodiments. For example, and as seen in FIG. 10, a mounting device 110 is shown employing the diaphragm spring 42 and the mounting section 50 with staggered branch rows 62a, 62b, 62c, 62d. An object support 120 is arranged differently from the previous drawings, and the mounting device 110 will have a wire or cable clipped into a clip 112 located on the mounting device 110, as opposed to the tie 12 used in the previously described embodiments. Similarly, FIG. 11 shows a mounting device 210 designed with the diaphragm spring 42, the mounting section 50 with staggered branch rows 62a, 62b, 62c, 62d, and, also, a clip 212 used in place of the tie 12. A mounting device 310 is depicted in FIG. 12 having the diaphragm spring 42, the mounting section 50 with staggered branch rows 62a, 62b, 62c, 62d, and alternative object support 320. Another embodiment of a friction tab 330 is also shown. The friction tab 330 provides resistance similar to the previously described friction tab 30. FIG. 13 shows a mounting device 410 having an alternative arrangement of an integral tie strap 12. The mounting device 410 utilizes the diaphragm spring 42 and the mounting section 50 with staggered branch rows 62a, 62b, 62c, 62d. FIG. 14 illustrates another mounting device 510 utilizing the mounting section 50 with staggered branch rows 62a, 62b, 62c, 62d, in which a toothed clip 512 is used to secure bundles 80 (not shown in this view). As is evident by these embodiments, the present invention may be used in many varying arrangements. The foregoing is considered as illustrative only of the principles of the invention. For instance, the tie 12 should be considered broadly to encompass a structure that will secure an object to the mounting device, such as the clips 112 and 212 shown in FIGS. 10 and 11. Likewise, the clips 112 and 212, or other similarly contemplated designs, should be understood as incorporated under the previously discussed aperture that the tie 12 interacts with. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/we claim:

1. A mounting assembly for anchoring an elongate member to a supporting structure, said mounting assembly including an integrally formed flexible tie having a tie tail for surrounding said bundled elongate member, said mounting assembly comprising:
a support containing an aperture, said aperture allowing insertion and withdrawal of said tie tail through said aperture, said support including a bottom surface;
a friction tab located in said aperture of said support, said friction tab providing resistance to longitudinal movement of said tie tail when said flexible tie is arranged in an assembled state; and
a mounting stud having a distal end and a proximal end, said proximal end of said mounting stud extending from said bottom surface of said support, said distal end being insertable into said supporting structure.

2. The mounting assembly according to claim 1 wherein said mounting stud further comprises:
a central section; and
a plurality of longitudinally spaced branches located on said central section, said branches extending outwardly from said central section and being arranged in a plurality of branch rows, said branch rows being asymmetrically arranged with respect to one another.

3. The mounting assembly according to claim 2 further comprising a diaphragm extending from said bottom surface, said diaphragm providing tension for said mounting assembly when said mounting stud is inserted into said supporting structure.

4. A mounting assembly for anchoring an elongate member to a supporting structure, said mounting assembly including an integrally formed flexible tie having a tie head and a tie tail for surrounding said elongate member, said mounting assembly comprising:
an object support located on said tie head, said tie head including a bottom surface and an aperture, said aperture allowing extension of said tie tail through said aperture;
a mounting stud, said mounting stud having a proximal end, said proximal end extending from said bottom surface of said tie head, said mounting stud being insertable into said supporting structure, said mounting stud having a plurality of branch rows, said branch rows being substantially coextensive with the lengthwise dimension of said stud; and
a plurality of longitudinally spaced branches respectively located on said branch rows and extending outwardly from said center section, said branches of said mounting stud, said branch rows being asymmetrically arranged with respect to one another.

5. The mounting assembly according to claim 4 wherein said branches are tapered upwards towards said bottom surface of said tie head.

6. The mounting assembly according to claim 4 wherein said branches in a first branch row are longitudinally spaced in parallel planes approximately half way between a pair of corresponding branches in a second branch row.

7. A mounting assembly for anchoring an elongate member to a supporting structure, said mounting assembly including an integrally formed flexible tie having a tie head and a tie tail for surrounding said elongate member, said mount comprising:
a support located on said tie head, said tie head containing an aperture, said aperture allowing extension of said flexible tie through said aperture, said support including a bottom surface;
a diaphragm extending from said bottom surface, said diaphragm providing tension for said mounting assembly when a mounting stud is inserted into said supporting structure; and
said mounting stud having a distal end and a proximal end, said proximal end of said mounting stud extending from said bottom surface and being insertable into said supporting structure.

8. The mounting assembly according to claim 7 wherein said diaphragm tapers outwardly from said bottom surface of said tie head.

9. The mounting assembly according to claim 7 wherein said diaphragm has a diameter greater than the diameter of said mounting stud.

10. The mounting assembly according to claim 7 further comprising a friction tab located in said aperture of said tie head, said friction tab providing resistance to longitudinal movement of said tie tail when said tie tail is arranged around said elongate member.

11. The mounting assembly according to claim 7 wherein said mounting stud further comprises:
a central section substantially coextensive with the lengthwise dimension of said stud;
a plurality of branch rows, said branch rows being substantially coextensive with the lengthwise dimension of said stud; and
a plurality of longitudinally spaced branches respectively located on said plurality of branch rows, said branches extending outwardly from said central section, said branches of a first branch row being asymmetrically arranged with respect to branches of a second branch row.

12. The mounting assembly according to claim 10 wherein said mounting stud further comprises:
a central section substantially coextensive with the lengthwise dimension of said stud;
a plurality of branch rows, said branch rows being substantially coextensive with the lengthwise dimension of said stud; and
a plurality of longitudinally spaced branches respectively located on said plurality of branch rows, said branches extending outwardly from said central section, said branches of a first branch row being asymmetrically arranged with respect to branches of a second branch row.
